(19) United States
(12) Patent Application Publication
(10) Pub. No.: US 2007/0150312 A1
(43) Pub. Date: Jun. 28, 2007

(54) METHOD AND APPARATUS FOR DISTRIBUTION OF VACCINE

(76) Inventor: Patrick M. Schmidt, Temecula, CA (US)

Correspondence Address: KIRKPATRICK & LOCKHART PRESTON GATES ELLIS LLP, 1900 MAIN STREET, SUITE 600, IRVINE, CA, 92614-7319, US

(21) Appl. No.: 11/615,776

(22) Filed: Dec. 22, 2006

Related U.S. Application Data
(60) Provisional application No. 60/753,498, filed on Dec. 23, 2005.

(51) Int. Cl. G06Q 10/00; G05B 19/418; G06Q 30/00

(52) U.S. Cl. 705/2; 705/8; 705/26

(57) ABSTRACT

According to a computer-implemented approach for scheduling and administering a vaccine to a patient, the patient submits information to an administrator. The administrator arranges a convenient appointment for the patient at a local medical provider to receive a vaccine. Provided that the patient is eligible and inventory of vaccine is available, the vaccine is administered to the patient at the pre-arranged appointment. According to another approach, a medical provider submits information to an administrator and if eligible, offers locations and appointments to provide vaccination services to a patient via the administrator. According to yet another approach, a supplier of vaccine submits information to an administrator and if eligible, offers inventory of vaccine to healthcare providers via the administrator. The patient, provider and supplier approaches may be used together or separately with a variety of vaccine distribution methodologies. Apparatus and computer-readable mediums implementing the above aspects are disclosed.

### CROSS REFERENCE TO RELATED APPLICATIONS

This application claims the benefit of U.S. Provisional Application No. 60/753,498, filed Dec. 23, 2005, and whose entire contents are hereby incorporated by reference.

### TECHNICAL FIELD

The present invention pertains to the distribution and administration of vaccines and other medical products.

### BACKGROUND

An important use of computers in modern times is the dissemination of information and transacting of business across a wide area network. Currently, the largest wide area computer network in existence is the Internet, although additional world-wide networks similar to the Internet are presently under development. The Internet is a worldwide interconnection of computer networks that communicate using a common protocol. Hundreds of millions of computers, from basic personal computers to high performance super computers are coupled to the Internet. The Internet was originated in the 1960s by the U.S. Defense Department. For a long time, the Internet was used by researchers in universities and national laboratories to share data and information. As the Internet became more widely known, users outside of the academic and research community started to utilize the Internet to transmit and receive electronic mail.

In 1989, a new type of information system known as the World Wide Web (the “web”) was introduced to the Internet. The web is a wide area information retrieval system giving users wide access to a universe of documents through a standard format of electronic file, known as the hyper text markup language (HTML). In 1993, researchers at the National Center for Supercomputing Applications (NCSA) released a web browser named “Mosaic” that implemented a graphical user interface (GUI) capable of viewing HTML files. Mosaic was a simple web browser to learn, yet afforded powerful capabilities. Since then, web browsers (i.e. Internet Explorer, Netscape, Firefox, etc.) have evolved into more sophisticated computer applications.

In modern times, the web browser, in conjunction with other computers on a wide area network such as the Internet, affords a means for offering “web services”. Web services encompass a broad spectrum of information dissemination or transactions that may have been traditionally effected by conventional correspondence means such as typewritten/handwritten paper, telephone or facsimile machines. For example, traditionally a person would go to the bank, or write a letter, to inquire as to one's account balance. In modern times, one can perform the same inquiries, receive the same information and even effect banking transactions via the Internet.

Unfortunately, the medical profession has been slow to embrace web services with respect to the distribution of vaccine and other medical products. Conventional vaccine distribution models are typically based upon distributing vaccines to medical providers based on population, geography or other statistical figures. Inventories of vaccines are allocated to medical service providers based on estimates of vaccines that will be manufactured and administered at the local, regional and national level. Such estimates, either in supply or demand of vaccines, may be significantly underestimated or overestimated, causing difficulty equally distributing vaccines to medical service providers across the nation. Alternatively, medical service providers are forced to purchase vaccines or other medical products in bulk, presenting a risk that such vaccines or medical products may not be administered to patients before the expiration of the vaccines or medical products.

Case in point, the United States has experienced disruptions in the manufacture and distribution of influenza vaccine during three of the recent half dozen influenza seasons. Delays in delivery of influenza vaccine or vaccine shortages remain possible, in part, because of the inherent time constraints in manufacturing vaccine and management of vaccine inventories, given the annual updating of the vaccine strains and uncertainties regarding vaccine supply and demand.

To exacerbate the difficulty of estimating the appropriate supply and demand for influenza vaccine each year, the Center for Disease Control, (“CDC”), establishes priority groups which vary from year to year. For example, for the 2003-2004 season, the priority groups were are follows. Tier 1A included persons age 65 years and older with comorbid conditions and residents of long-term care facilities. Tier 1B included persons age 2 through 64 years with comorbid conditions, persons age 65 years and older without comorbid conditions, children aged 6 to 23 months and pregnant woman. Tier 1C included healthcare personnel and household contacts and out-of-home caregivers of children over 6 months old. Tier 2 included household contacts of children and adults at increased risks for influenza related complications and healthy persons aged 50 to 64 years. Tier 3 included persons aged 2 to 49 years without high risk conditions. Certain persons could be included in more than one group.

For the 2004 and 2005 seasons, the CDC identified eight priority groups of equal importance: children aged 6 to 23 months, adults aged 65 years and older, persons aged 2 to 64 years with underlying chronic medical conditions, all women who would be pregnant during the influenza season, residents of nursing homes and long-term care facilities, children aged 6 months to 18 months on chronic aspirin therapy, healthcare workers involved in direct patient care, out-of-home caregivers and household contacts of children aged under 6 months.

The above case examples illustrate that eligibilities and priorities for distribution of vaccines frequently change, and the changing supply and demand may be difficult to assess from year-to-year.

Moreover, as noted above, conventional vaccine distribution models require a burdensome analysis in order to determine eligibility and priority of distribution. Given the complex formula to determine simply whether a given person is eligible and/or prioritized to receive a vaccine, this difficulty is exponentially compounded when attempting to generate estimates on a bulk scale. This complicated process may, and has, caused both overages and shortages at local, regional and national levels. It would be highly desirable to remove the human analysis aspects of such distribution.

On a practical note, the present avenues for obtaining a vaccine, such as the influenza (or flu) vaccine, are also inefficient and cumbersome to the public. Typically, groups of persons contract for a medical services provider to acquire and administer a bulk number of vaccine dosages to a group at a pre-arranged, inflexible time. Such a date and time may be inconvenient for a portion of the group, causing a number of persons not to receive the vaccine at all.

Further, if a person is not a member of such a group that contracts for the administering of vaccines, availability, scheduling and administering of a vaccine can be quite cumbersome, typically requiring research and a substantial number of telephone calls for the average patient.

Given the above systematic and logistical problems caused by conventional models of vaccine distribution, an approach for distributing vaccines to persons that alleviates or mitigates such burdensome analyses, erroneous estimates, market fluctuations, medical service provider risks of over- or under-inventory, regulatory changes and logistical barriers is badly needed in the medical profession. While the flu vaccine presents an exemplary case in point to demonstrate the need for a better solution, this need is felt on a broader level for many medical products requiring administration by a medical professional; and, likewise, other professional service trades would also enjoy the benefits of such an improved distribution system.

Therefore, an approach for allocating, scheduling, distributing and administering vaccines and medical goods based on real-time supply and demand, through computer-implemented means, is highly desirable.

### SUMMARY

My invention is directed to a method and system for intelligently and efficiently distributing a vaccine or other medical products that necessarily need to be administered by a medical professional. In a best mode contemplated in an embodiment of my invention, a patient requesting to be provided a flu vaccine visits the website of a vaccine administrator, exchanges information with an administrator regarding eligibility and billing, reserves an appointment with a medical provider to provide the vaccine, attends the appointment thereby receiving a vaccination, and effects all administrative tasks regarding the vaccination via the Internet.

Various approaches for distributing vaccine or medical products disclosed herein contemplate a variety of aspects of the invention when observed from the perspective of a patient, a medical services provider, a vaccine manufacturer/supplier and an administrator who coordinates the communication and administrative tasks between these parties.

According to one aspect, a vaccine supplier desires to supply its inventory of vaccine to a patient via a medical services provider. The vaccine supplier exchanges information to an administrator via a wide area network to determine the vaccine supplier's eligibility and allocate the vaccine supplier's inventory of vaccine. Following the request of the administrator for the vaccine supplier to transfer an inventory of vaccine to a medical services provider, the vaccine is supplied to the medical services provider via conventional vaccine distribution channels. Additional administrative or regulatory information is exchanged between the vaccine supplier, the medical services provider and the administrator via the administrator link.

According to another aspect, a medical services provider desires to provide vaccine to patients. The medical services provider submits information to an administrator via a wide area network to determine its eligibility as a medical services provider for the prospective patients to be presented by an administrator. The medical services provider also submits information regarding its pool of available appointments for such prospective patients. Following the selection (or reservation) of an appointment by a patient via the wide area network, the administrator removes the chosen appointment from the medical service provider's pool of available appointments. When the patient attends the pre-arranged appointment at the medical service provider's premises, the vaccine is administered to the patient via conventional means, (i.e. physical transfer of possession of the vaccine or injecting the vaccine into the patient, etc.). Following the vaccination, post-treatment communication and administrative information is exchanged between the medical services provider, the patient and the administrator via the wide area network.

According to yet another aspect, a patient desires to be provided a vaccine. The patient initiates contact with an administrator via a wide area network, (i.e. the patient visits the website of the administrator via the Internet), and exchanges information with the administrator to determine the eligibility and billing arrangements of the vaccine to be administered to the patient. Based on an available supply of vaccine from suppliers and an available pool of appointments from one or more medical service providers, the patient selects (or reserves) an appointment to be provided the vaccine via the wide area network. Following the selection of an appointment by the patient via the wide area network, the administrator reserves the appointment for the patient and removes the appointment from the pool of available appointments provided by the medical services provider. Upon attending the pre-arranged appointment, the vaccine is provided by to the patient by the medical services provider via a conventional means. Subsequently, post-treatment communication and administrative information is exchanged between the provider, the patient and the administrator via the wide area network.

In yet other embodiments, apparatus and computer-readable mediums implementing the above aspects are disclosed. These and other features, aspects and advantages of the present invention will be more fully understood when considered with respect to the following detailed description and accompanying drawings.

It is understood that while the term “vaccine” is used to describe specific details of a best mode of practice of the invention, the term “vaccine” as defined in the present disclosure also contemplates any singular or plural medical product provided or administered to a patient by a healthcare provider.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a diagram depicting an approach for distributing vaccines to patients according to an embodiment;

FIG. 2 is a flow diagram depicting an approach for distribution of a vaccine and identifying patient-related steps according to one embodiment of the invention;

FIG. 3 is a flow diagram depicting an approach for distribution of a vaccine and identifying provider-related steps according to one embodiment of the invention;

FIG. 4 is a flow diagram depicting an approach for distribution of a vaccine and identifying supplier-related steps according to one embodiment of the invention;

FIG. 5 is a block diagram of computer software upon which embodiments of the invention may be implemented;

FIG. 6 is a diagram depicting an approach for distribution of vaccines utilizing the Internet according to an embodiment of the invention; and

FIG. 7 is a block diagram of a computer system upon which embodiments of the invention may be implemented.

FIG. 8 is a block diagram of a computer system upon which embodiments of the invention may be implemented.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessary obscuring of the invention. Section titles and references appearing within the following paragraphs are intended for the convenience of the reader and should not be interpreted to restrict the scope of the information presented at any given location.

Various aspects and features of example embodiments of the invention are described in more detail hereinafter in the following sections: (1) Functional Overview, (2) Patient-Related Steps, (3) Provider-Related Steps, (4) Supplier-Related Steps, (5) Implementation Mechanisms, (6) Additional Embodiments, (7) Conclusion and (8) Present Disclosure.

### Functional Overview

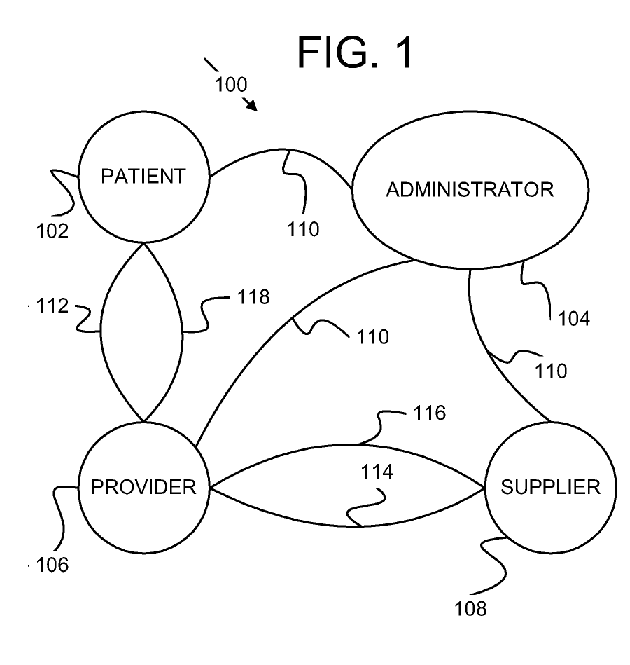

FIG. 1 is a block diagram 100 that illustrates an approach for distribution of vaccine according to various embodiments described herein. As used herein, the term “vaccine” refers to any singular or plural medical good that can be provided or administered to a patient. Examples of vaccine include vaccines (i.e. flu vaccine), medications (i.e. intravenous or oral medications), medical apparatus (i.e. pacemakers or diagnostic equipment), and other medical-related goods requiring an appointment with a medical services provider. Likewise, as used herein, the term “vaccination” generally refers to the action of providing a vaccine to a patient. As used herein, the term “provide” or “providing”, when used in the context of vaccine, generally refers to the transfer of physical possession, treatment or administering of a vaccine to a patient from a healthcare provider. More broadly, as used herein, the term “distribute”, “distributing” and “distribution”, and various forms thereof, encompasses not only the providing of a vaccine to a patient, but more generally refers to all administrative and logistical tasks before and after the providing of a vaccine to a patient. (For example, determination of eligibility or priority of a patient, determination of local medical service providers for the patient, allocation of vaccine, shipment and receipt of vaccine, billing and payment arrangements, scheduling arrangements, post-treatment notices, regulatory information dissemination, etc.).

According to one embodiment, a patient 102 submits information, namely biographical, health and billing information to an administrator 104 over an administrator link 110. Administrator link 108 confirms that patient 102 requests to receive a vaccine from a provider 104 located in convenient proximity to patient 102.

In response to receiving biographical, health and billing information from patient 102, administrator 104 initiates certain steps to accommodate the request from patient 102, including the scheduling of an appoint with a provider 106 and procurement of a vaccine from a supplier 108. Generally, administrator 104 must determine whether the patient 102 is eligible to receive a vaccine and whether a vaccine can be supplied from supplier 108 in a timely fashion, along with other considerations necessary to administer such a vaccine such as scheduling and payment. These conditions and logistics are determined and effected through the administrator link 110, provider link 112 and the supplier link 114.

The administrator link 110, provider link 108 and the supplier link 110 may be any medium for transferring information or data between patient 102, administrator 104, provider 106 and supplier 108, and the invention is not limited to any particular medium. Examples of an administrator link 110, provider link 112 and supplier link 114 include, without limitation, a network such as a local area network (LAN), a wide area network (WAN) or the Internet, a telecommunications link, a radio frequency (RF) link, a wire or optical link or a wireless connection.

Upon the favorable determination of the aforementioned conditions and successful arrangement of the aforementioned logistics, the vaccine is supplied from the supplier 108 to the provider 106 via a supplier channel 116. As used herein, the term “supply” or “supplying” generally refers to the transfer of physical possession of a vaccine from a supplier 108 to a provider 106. Supplier channel 116 may be implemented by any person, mechanism or medium that ships, delivers or otherwise transfers physical possession of a vaccine from a supplier 108 to a provider 106, including, without limitation, mail delivery, courier delivery, delivery using a delivery agent or other conventional means of shipment. For example, in a preferred embodiment supplier 108 supplies batches of vaccine to provider 106 via supplier channel 116, such as supplier 108 transferring 1,000 units of vaccine to provider 106 via a conventional shipping company, (i.e. United Parcel Service, Federal Express, etc.)

Upon receipt of the vaccine, pursuant to the aforementioned pre-arranged logistics, provider 106 provides the vaccine to patient 102 via a provider channel 118. Provider channel 118 may be implemented by any person, mechanism or medium that provides, treats, administers or otherwise provides a vaccine to a patient 102. Typically, a provider channel 118 comprises a medical physician, a registered nurse or other healthcare worker licensed to administer a vaccine directly to a patient. For example, in a preferred embodiment a flu vaccine is provided to a patient 102 by provider channel 118, namely provider channel 118 comprising a registered nurse who injects the flu vaccine into the patient 102.

Prior to, during, or subsequent to provider 106 providing the vaccine to patient 102, certain tasks comprising disclosure of information, billing, payment and other transactional or administrative tasks relating to the providing of the vaccine are performed by administrator 104, patient 102, provider 106 or supplier 108. These steps, and the aforementioned steps above, are further detailed in additional figures and paragraphs that follow.

### Patient-Related Steps

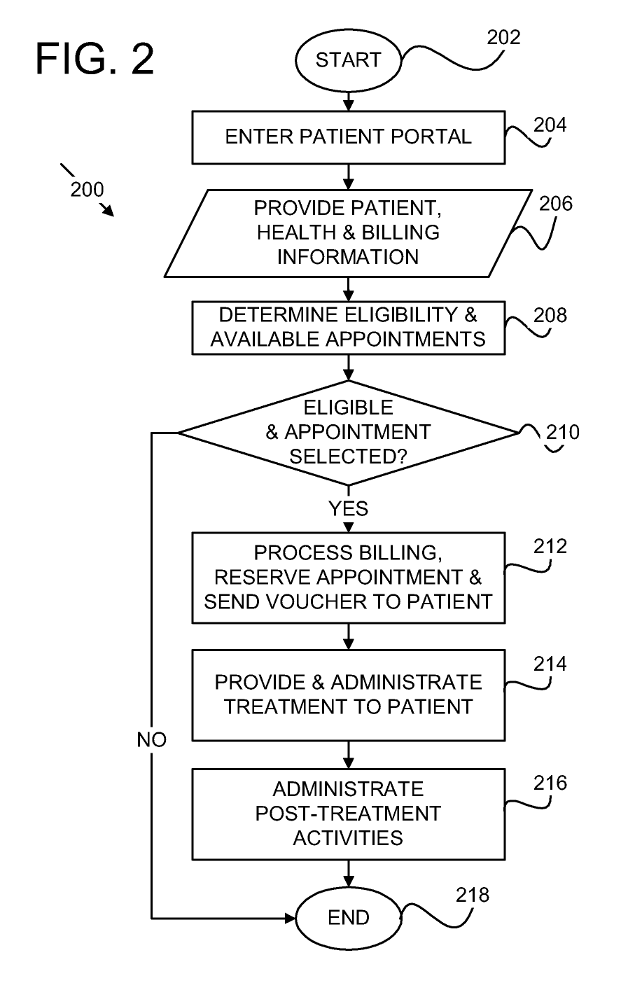

Turning to FIG. 2, the approach just described for distributing vaccine will now be described in greater detail with reference to a diagram 200, a flow diagram of an embodiment illustrating steps associated with a patient 102. Speaking in general terms, a patient 102 submits information necessary to secure an appointment to receive a vaccine, selects an appointment from various appointment options, (if eligible and available), and subsequently attends the appointment.

After starting in step 202, in step 204 the patient 102 consents to certain notices and transmits information to an administrator 104 via an administrator link 110. Typically, the patient 102 first consents to receive notices via the administrator link 110 and further confirms that all transactions the consumer conducts with the administrator 110 will be conducted via the administrator link 110. In preferred embodiments, the patient 102 will immediately receive one or more notices including a notice of patient privacy via the administrator link 110.

Following the just described consent and confirmation of the patient 102, biographical information (i.e. name, address, zip code, etc.), health information, (i.e. gender, age, answers to specific health-related questions, etc.), and billing information, (i.e. credit card number, etc.), is submitted by the patient 102 and transmitted to the administrator 104 via the administrator link 110. Typically, the patient 102 will authorize the administrator 104 to either confirm the billing information or effect payment for the cost of the vaccine and services to be rendered to the patient 102.

The Centers for Disease Control (“CDC”) establish annual criteria to determine various priority groups for patients seeking to obtain a given vaccine. Utilizing such criteria, step 208 analyzes the health information from step 206 to determine the appropriate CDC priority group for the patient 102 with respect to the requested vaccine. Such a determination in step 208 will dictate whether the patient 102 is eligible to be provided a vaccine, and if so, what available locations and appointments for a provider 106 would be most convenient for the patient 102 based on the biographical information (i.e. patient's address and zip code) submitted by the patient 102 in step 206.

In step 210, the administrator 104 will retrieve, either from its own databases or databases of a provider 106, the pool of available appointments that would be convenient for the patient 102 to attend. This pool of appointments is utilized to develop appointments and scheduling options to be presented to the patient 102 via the administrator link 110. The administrator 104 typically utilizes a number of factors to arrive at one or more options for the patient 102, based on the CDC priority group determined in step 208, the biographical information transmitted in step 206 and the pool of available appointments retrieved in the present step 210. Note that step 210, if desired and logistically possible, affords a variety of options for schedules and locations for more than one provider 106.

At this juncture, the patient 102 typically selects one of the appointments. If the patient 102 is not eligible to be provided a vaccine, or the patient 102 does not select an appointment, the process is aborted at step 218.

Upon selection an appointment or scheduling option in step 210, step 212 encompasses a number of post-scheduling tasks. In a preferred embodiment, billing or payment of the vaccine and related services (if not already processed in step 206) is effected in step 212. The specific appointment chosen is also removed from the pool of available appointments associated with the provider 106. Lastly, a notice of the reservation is sent to the patient 102 via either the administrator link 110, a provider link 108, or a combination of both.

In preferred embodiments, the notice of reservation takes the form of a unique voucher. The voucher is capable of, by normal or encrypted language or syntax, of identifying and entitling the patient 102, at a subsequent date/time and location, to be provided the vaccine by the provider 106. The voucher can be a alphanumeric code, number or any item manifesting a unique identification, (i.e. a physical ticket with a bar code, a computer chip transmitting a passive or active signal, etc.).

During step 212 the patient 102 may also receive various health notices via the administrator link 110 or the provider link 108 relating to the vaccine (i.e. side effects regarding flu vaccines), logistics (i.e. directions regarding how to get to the provider) or other notices, (i.e. a receipt of the financial transaction arrangements).

Pursuant to the pre-arranged appointment selected in step 210, the patient attends the appointment and provider 106 provides the vaccine to the patient 102 in step 214. As noted above, in preferred embodiments, the patient 102 should be required to submit the voucher provided in step 212 to confirm identification and eligibility prior to providing the vaccine to the patient 102.

Following step 214, in step 216 the administrator 104, the patient 102, the provider 106 and the supplier 108 administrate post-treatment activities and communicate post-treatment information to one another via the administrator link 110, the provider link 112 and the supplier link 114. Examples of such post-treatment activities and information comprise notices regarding the vaccine provided, information relating to the lot numbers of the vaccine administered, symptoms or complications experienced by the patient 102, follow-up vaccines or other treatments that are necessary, or solicitation of other vaccines or services offered by the administrator 104 and provider 106.

The process, with respect to the patient 102, is complete in step 218.

### Provider-Related Steps

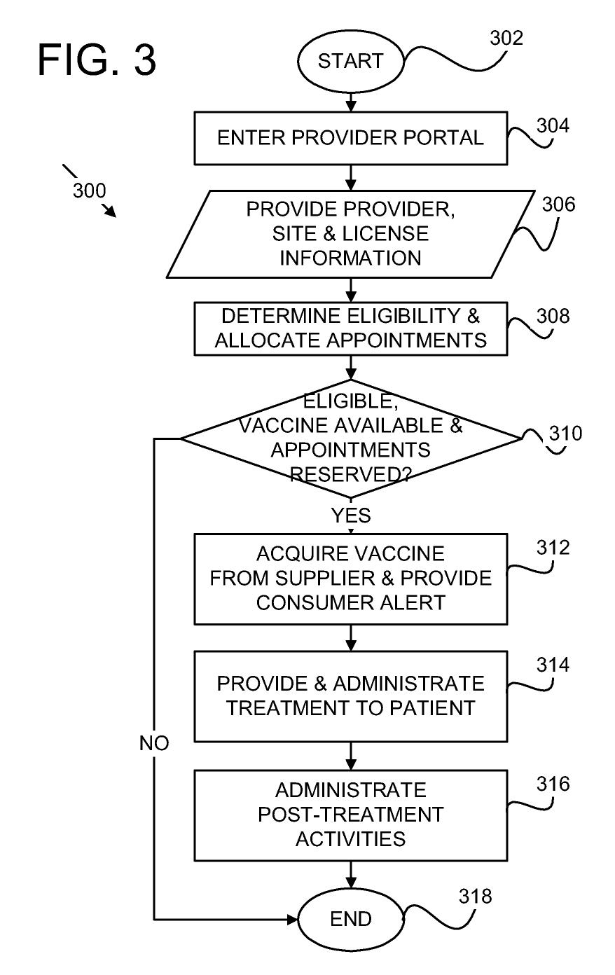

Turning to FIG. 3, the approach described above for distributing vaccine will now be described with reference to a diagram 300, a flow diagram of an embodiment illustrating steps associated with a provider 106. Speaking in general terms, a provider 106 submits information necessary to qualify itself as a provider 106 of a vaccine, submits information regarding a pool of appointments available to render services in conjunction with the vaccine, provides these services to a patient 102, and subsequently administrates post-treatment activities.

As generally indicated above, after starting in step 302, in step 304 a prospective provider initiates the process of qualifying itself as a provider 106. This step may be as simple as visiting the website of the administrator and impliedly agreeing to the terms of use. In more sophisticated embodiments, the communication of preliminary information from the administrator 104 to the provider 106 is accommodated.

In step 306, the provider 106 submits information necessary to enter into contractual relations with an administrator 104 to provide a vaccine to prospective patients. Typically, such information is related to one or more licenses to offer medical services that the provider 104 may possess, and more particularly, one or more licenses required to administer a vaccine to a patient 102. Such contractual relations negotiated and accepted by the parties can have varying terms and conditions relating to billing, payment, procurement of vaccine and other critical terms. This step can be performed via an administrator link 110 or any conventional means of communication such as telephone, facsimile, mail correspondence, etc.

Upon a confirmation by the administrator 104 that the provider is eligible to provide vaccination services to patients, and upon the commencement of a business relationship between the administrator 104 and the provider 106, (which again can be effected by either an administrator link 110 or other conventional means of conducting business), the provider 106 is determined to be eligible to offer vaccination services in step 308. Continuing step 308, which can be updated from time to time by the provider 106, the provider 106 submits a list of geographic sites (or physical locations) for vaccine to be provided, as well as a pool of available appointments at these site, so as to offer scheduling options to the administrator 104 via the administrator link 110.

At this juncture, the provider 106 and administrator 104 are in the position to accept and effect reservations from a patient 102 for a prospective appointment between a patient 102 and a provider 106, based on the pool of available registrations submitted by the provider 106. Provider 106 awaits such notice of reservations from the administrator 104.

In step 310, the administrator 104 transmits a reservation for the details of a specific appointment selected by a patient 102 via the administrator link 110. Receipt of the reservation by the provider 106 from the administrator 104 via the administrator link 110 communicates a number of details and terms, namely: (i) that the administrator has confirmed the eligibility of the provider 106 to provide the vaccine and related services to the patient 102, that (ii) the administrator has removed the specific appointment from the pool of available appointments, and (iii) that available inventory of the vaccine is estimated to be sufficient to fulfill the provision of the vaccine to the patient 102.

Subsequent to receipt of the reservation, the provider 106, either solely or in conjunction with the administrator 104, requests vaccine from a supplier 108 via a supplier link 114 in step 312. Depending upon the contractual relationships and terms agreed by the administrator 104, provider 106 and supplier 108, payment to supplier 108 for the vaccine can be timed and effected in a variety of forms, shared or wholly effected by either the administrator 104 and/or the provider 106. Continuing with step 312, the vaccine is then supplied to the provider 106 via the supplier channel 116.

In preferred embodiments, in addition to the above, in step 312 the provider 106 or the administrator 104 will typically provide a consumer alert notice to the patient 102 via either the administrator link 110 or the provider link 112.

In step 314, the patient 102 attends the reserved appointment at the pre-determined location and receives the vaccine and related services from the provider 106. Prior to rendering the vaccine and related services, in preferred embodiments a voucher provided to the patient 102 in step 212 should be received by the provider 106. The voucher confirms the identity and entitlement of the patient 102 to attend the appointment and receive the vaccine and services to be rendered.

Following step 314, in step 316 the administrator 104, the patient 102, the provider 106 and the supplier 108 administrate post-treatment activities and communicate post-treatment information to one another via the administrator link 110, the provider link 112 and the supplier link 114. Examples of such post-treatment activities and information comprise notices regarding the vaccine provided, information relating to the lot numbers of the vaccine administered, symptoms or complications experienced by the patient 102, follow-up vaccines or other treatments that are necessary, or solicitation of other vaccines or services offered by the administrator 104 and provider 106.

The process, with respect to the provider 106, is complete in step 318.

### Supplier-Related Steps

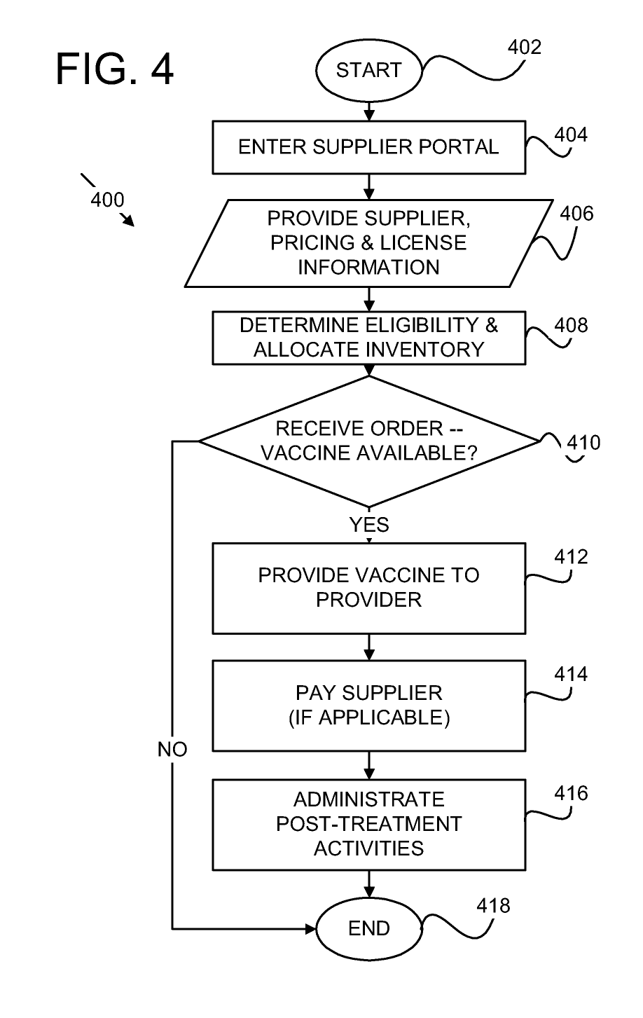

Turning to FIG. 4, the approach described above for distributing vaccine will now be described with reference to a diagram 400, a flow diagram of an embodiment illustrating steps associated with a supplier 108. Speaking in general terms, a supplier 108 submits information necessary to qualify itself as a supplier 108 to an administrator 104, submits ongoing information regarding its manufacture, handling, inventory and pricing of vaccine to the administrator 104, upon request supplies the vaccine to a provider 106, and subsequently administrates post-treatment activities.

As generally indicated above, after starting in step 404, in step 404 a prospective supplier initiates the process of qualifying itself as a supplier 108. This step may be as simple as visiting the website of the administrator, impliedly agreeing to the terms of use. In more sophisticated embodiments, the communication of preliminary information from the administrator 104 to the provider 106 is accommodated.

In step 306, the provider 106 submits information necessary to enter into contractual relations with an administrator 104 to provide a vaccine to prospective patients. Typically, such information is related to one or more licenses to manufacture, handle and transport medical products, and more particularly, one or more licenses required to manufacture, handle and transport a vaccine to a provider 106. Such contractual relations negotiated and accepted by the parties can have varying terms and conditions relating to billing, payment, procurement of vaccine and other critical terms. This step can be performed via an administrator link 110 or any conventional means of communication such as telephone, facsimile, mail correspondence, etc.

Upon a confirmation by the administrator 104 that the supplier is eligible to manufacture, handle and transfer vaccine to a provider 106, and commencement of a business relationship between the supplier 108 and the administrator 104, (which again can be effected by either an administrator link 110 or other conventional means of conducting business), in step 408 the administrator 104 determines whether the supplier 108 is eligible to supply vaccine to a provider 106. Continuing step 408, which can be updated from time to time by the supplier 108, the supplier 108 submits an estimated inventory of vaccine, based on present and future chronological periods or other categories, to administrator 104.

At this juncture, the supplier 108 and administrator 104 are in the position to accept orders for the supply of vaccine to the provider 106, based on the available inventory reflected in step 408. Supplier 108 therefore awaits requests or orders from either the administrator 102 or the provider 106 to supply vaccine to the provider 106. Such requests or orders are not necessary to take the form of a single order, but can be communicated in small or large batches, (i.e. orders of 10, 100, 1000, 10000, etc.).

Upon receipt of an order in step 410, the supplier 108 must determine whether sufficient physical quantity of vaccine is available or can be manufactured in a timely fashion to fulfill the order. If not, such a deficiency should be immediately communicated to the administrator 104 and the process aborted at step 418.

Assuming that sufficient inventory of vaccine is available, in step 412 the vaccine is supplied by the supplier 108 to the provider 106. In step 414, depending upon the contractual relationships and terms agreed by the administrator 104, provider 106 and supplier 108, payment to supplier 108 for the vaccine can be timed and effected in a variety of forms, shared or wholly effected by either the administrator 104 and/or the provider 106.

Following step 414, in step 316 the administrator 104, the patient 102, the provider 106 and the supplier 108 administrate post-treatment activities and communicate post-treatment information to one another via the administrator link 110, the provider link 112 and the supplier link 114. Examples of such post-treatment activities and information comprise notices regarding the vaccine provided, information relating to the lot numbers of the vaccine administered, symptoms or complications experienced by the patient 102, follow-up vaccines or other treatments that are necessary, or solicitation of other vaccines or services offered by the administrator 104 and provider 106.

The process, with respect to the supplier 108, is complete in step 418.

### Implementation Mechanisms

The approach described herein for determining eligibility, scheduling, distributing and administering a vaccine is applicable to any type of medical product or medical procedure requiring professional services, and is particularly well suited for Internet-based scheduling and administration of flu vaccines. The invention may be implemented in hardware circuitry, in computer software, or a combination of hardware circuitry and computer software and is not limited to a particular hardware or software implementation.

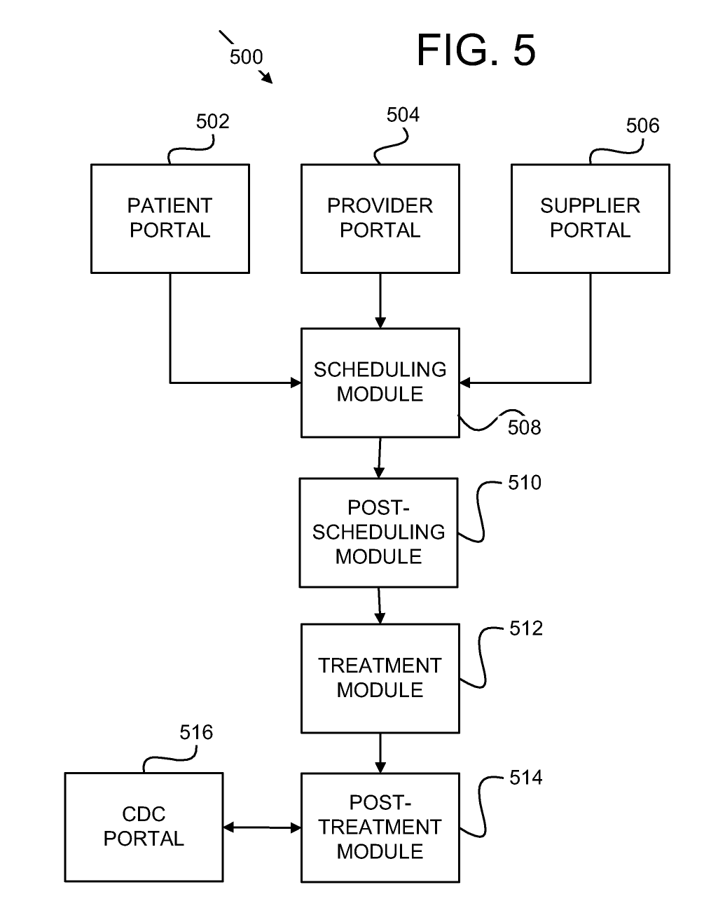

FIG. 5 is a block diagram illustrating a software architecture capable of implementing one or more of the above disclosed embodiments of the invention. More particularly, a patient portal 502 serves as a vehicle to submit and transmit information to and from a patient 102, and make determinations of eligibility of a patient 102 to be provided a vaccine, as detailed in steps 202 through 208. With respect to a provider 106, a provider portal 504 serves as a vehicle to submit and transmit information to and from a provider 106, and make determinations of eligibility of a provider 106 in its capacity to provide a vaccine to a patient 102, as detailed in steps 302 through 308. Likewise, a supplier portal 506 serves as a vehicle to submit and transmit information to and from a supplier 108, and make determinations of eligibility of a supplier 108 in its capacity to supply vaccine to a provider 106, as detailed in steps 402 through 408.

A scheduling module 508 serves as a central intelligence to coordinate a patient 102, a provider 106 and a supplier 108 to effect the distribution of vaccine from a supplier 108 to a provider 106 to a patient 102. Therefore, the scheduling module is typically responsible for steps 210, 310 and 410, respectively coordinating the scheduling of an appointment of a patient 102 and procurement of a vaccine for such an appointment. A post-scheduling module 510 typically handles steps 212, 312 and 412, thereby effecting notices, billing, payment and other transactional or logistical matters.

A treatment module 512 namely interfaces with a provider channel 112, thereby administrating the individual vaccine characteristics (i.e. lot number, etc.) and medical charting typically associated with step 214.

A post-treatment module 514 administrates post-treatment activities of steps 216, 316 and 416, namely the collection, recordation and dissemination of information relating to the vaccine, services rendered or other products/services.

Additionally, in preferred embodiments, a CDC portal 516 is preferable to implement, thereby disclosing to the CDC any/all information regarding a vaccine provided to a patient or the services rendered by a provider 106.

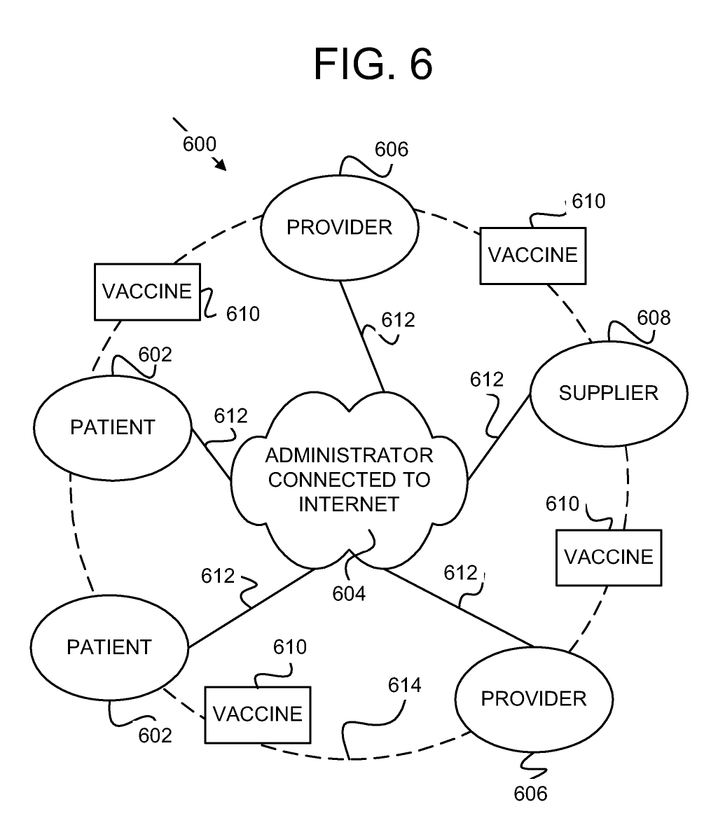

Turning to FIG. 6, another approach for distribution of vaccine herein is now described. FIG. 6 is a diagram 600 depicting a centralized architecture for the distribution of vaccine, wherein an administrator 604 handles communications with respect to a patient 602, a provider 606 and a supplier 608 via an administrator link 612, which may be a plurality of such connections to one or more parties.

In one aspect, a supplier 608 desires to supply a vaccine 610 to a provider 606. The supplier 608 submits information to an administrator 604 via an administrator link 612, namely a communications means such as a wide area network (i.e. the Internet), to determine the eligibility of supplier 608 and update records regarding inventory of the vaccine 610 from supplier 608. Administrator 604 accepts and processes such information, subsequently configuring its information systems to allocate or make available the vaccine 610 of supplier 608 to the provider 606 or a patient 602. Following the request of the administrator 604 for supplier 608 to supply the vaccine 610 to the provider 606, the vaccine 610 is supplied to provider 606 via a conventional channel 614 (i.e. postal shipment, courier shipment, etc.). Following the supplying of the vaccine 610 to provider 606, information is exchanged between the supplier 608, the provider 606 and the administrator 604 via an administrator link 612.

In another aspect, a provider 606 desires to provide a vaccine 610 to a patient 602. The provider 606 submits information to an administrator 604 via an administrator link 612 to determine the eligibility of provider 606 and update records regarding the availability of appointments from provider 606 to provide vaccine to a patient 602. Administrator 604 accepts and processes such information, subsequently configuring its information systems to allocate or make available a pool of available appointments of provider 606 to the patient 602. Following the selection by the patient 602 of an appointment, via the administrator link 612, the administrator 604 removes the chosen appointment from its pool of available appointments. Upon attending the pre-arranged appointment by the patient 602 at the provider 606, the vaccine 610 is provided by provider 606 to the patient 602 via a conventional channel 614 (i.e. physical transfer of possession of the vaccine 610, medical treatment of the vaccine 610, etc.). Following the providing of the vaccine 610 to patient 602, post-treatment communications and administrative information is exchanged between the provider 606, the patient 602 and the administrator 604 via an administrator link 612.

In yet another aspect, a patient 602 desires to be provided a vaccine 610. The patient 602 initiates electronic contact with an administrator 604 via an administrative link 612, (i.e. the patient 602 visits the website of the administrator 604 via the Internet), and exchanges information with the administrator 604 via an administrator link 612 to determine the eligibility and billing arrangements of patient 602 to be provided a vaccine 610. Administrator 604, based on an available supply of vaccine 610 and an available pool of appointments from a provider 606, exchanges information with patient 602 to select an appointment for patient 602 to be provided a vaccine 610 via the provider 606. Following the selection by the patient 602 of an appointment, thereby reserving the appointment, the administrator 604 removes the chosen appointment from its pool of available appointments. Upon attending the pre-arranged appointment by the patient 602 at the provider 606, the vaccine 610 is provided by provider 606 to the patient 602 via a conventional channel 614 (i.e. physical transfer of possession of the vaccine 610, medical treatment of the vaccine 610, etc.). Following the providing of the vaccine 610 to patient 602, post-treatment communications and administrative information is exchanged between the provider 606, the patient 602 and the administrator 604 via an administrator link 612.

It is appreciated that the administrator link 612 may take any number of forms of communication, but is preferably implemented as electronic communication via a wide area network such as the Internet. It is further appreciated that various distinct entities described in the above method and system, namely the administrator 104, provider 106 and supplier 108, may be one of the same entity, subject to the laws and regulations posed by the subject entity's jurisdiction. By way of example without limitation, it is anticipated that in some embodiments of the present invention it is possible that an administrator 104 is the same entity as a provider 106, or alternatively that a provider 106 is the same entity as a supplier 108.

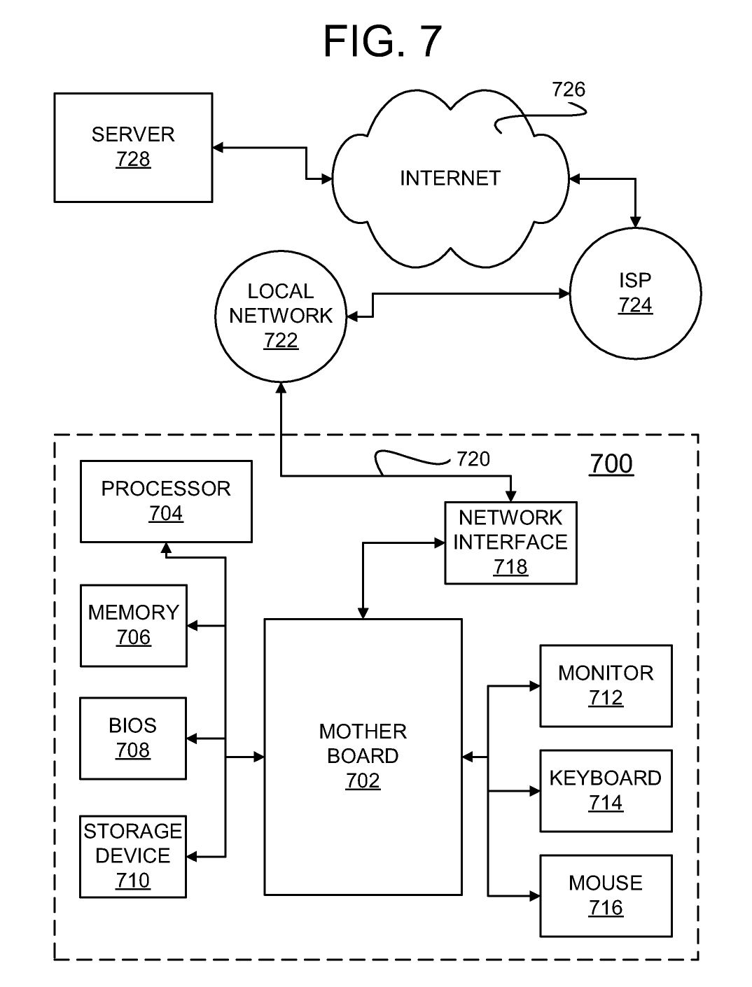

Turning to FIG. 7, a block diagram illustrates a computer 700 upon which an embodiment of the invention may be implemented. Computer 700 includes a motherboard 702 or other communication mechanism for communicating information, and a processor 704 coupled with motherboard 702 for processing information. Computer 700 also includes a memory 706, such as a random access memory (RAM) or other dynamic storage device, coupled to motherboard 702 for storing information and instructions to be executed by the processor 704. Memory 706 also may be used for storing temporary variables or other intermediate information during execution of instructions to be executed by processor 704. Computer 700 further includes a basic input output system (BIOS) 708 or other static storage device coupled to motherboard 702 for storing static information and instructions for processor 704. A storage device 710, such as a magnetic disk or optical disk, is provided and coupled to bus 702 for storing information and instructions.

Computer 700 may be coupled via motherboard 702 to a monitor 712, such as a cathode ray tube (CRT) or liquid crystal display (LCD) for displaying information to a computer user. An keyboard 714, including alphanumeric and other keys is coupled to motherboard 702 for communicating information and command selections to processor 704. Another type of user input device is a mouse 716, such as a mouse, a trackball, or cursor direction keys for communicating direction information and command selections to processor 704 and for controlling cursor movement on monitor 712. This input device typically has degrees of freedom in two axes, a first axis (e.g., x) and a second axis (e.g., y), that allows the device to specify positions in a plane.

The invention is related to the use of computer 700 as a conduit for information transmission with a server 730. Such information may, by way of example, include information regarding personal, medical and billing information from prospective patients, information regarding the scheduling of a appointment for medical services and information regarding the administration of medical services. According to one embodiment of the invention, the scheduling of an appointment for a prospective patient is provided by computer 700 in response to processor 704 executing one or more sequences of one or more instructions contained in memory 706. Such instructions may be read into memory 706 from another computer-readable medium, such as storage device 710.

Execution of the sequences of instructions contained in memory 706 causes processor 704 to perform the process steps described herein. One or more processors in a multi-processing arrangement may also be employed to execute the sequences of instructions contained in memory 706. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as memory 706. Transmission media includes coaxial cables, copper wire and fiber optics, including the wires that comprise motherboard 702. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. Motherboard 702 carries the data to and from memory 706, from which processor 704 retrieves and executes the instructions. The instructions received by memory 706 may optionally be stored on storage device 710 either before or after execution by processor 704.

Computer 700 also includes a network interface 718 coupled to motherboard 702. Network interface 718 provides a two-way data communication coupling to a network link 720 that is connected to a local network 722. For example, network interface 718 may be a digital subscriber line (DSL) modem, satellite dish, an integrated services digital network (ISDN) card or other data communication connection to a corresponding type of telephone line. As another example, communication interface 718 may be a local area network (LAN) card effecting a data communication connection to a compatible LAN. Wireless communication means such as internal or external wireless modems may also be implemented.

In any such implementation, network interface 718 sends and receives electrical, electromagnetic or optical signals that carry digital data streams representing various types of information. Network link 720 typically provides data communication through one or more networks to other data devices. For example, network link 720 may effect a connection through local network 722 to a host computer 724 or to data equipment operated by an Internet Service Provider (ISP) 724. ISP 724 in turn provides data communication services through the world wide packet data communication network now commonly referred to as the “Internet” 728. Local network 722 and Internet 726 both use electrical, electromagnetic or optical signals that carry digital data streams. The signals through the various networks and the signals on network link 720 and through network interface 718, which carry the digital data to and from computer system 700, are exemplary forms of carrier waves transporting the information.

Computer 700 can send messages and receive data, including program code, through the network(s), network link 720 and network interface 718. In the Internet example, a server 728 might transmit a requested code for an application program through Internet 726, ISP 726, local network 722 and network interface 718. In accordance with the invention, one such downloaded application provides for the scheduling of an appointment or payment of services for a patient as described herein. The received code may be executed by processor 704 as it is received, and/or stored in storage device 710, or other non-volatile storage for later execution. In this manner, computer 700 may obtain application code in the form of a carrier wave.

### Additional Embodiments

While the above disclosure describes in detail a comprehensive method and system for the distribution and administration of vaccine and medical products between several entities, (e.g. between a patient 102, a provider 106 and a supplier 108 with the assistance of an administrator 104), additional embodiments of the present invention are also anticipated on a smaller scale incorporating sub-portion(s) of the above embodiments.

For example, embodiments of the present invention can also be implemented to benefit the discrete business transactions of vaccine occurring between a supplier 108 and a provider 106. A supplier 108 can offer a provider 106 the privilege of choosing a specific delivery day for an order of vaccine. Offering such resolution as to choice of delivery date (e.g. to the specific day) is novel in the vaccine distribution industry, as vaccine suppliers typically deliver batches of vaccines into the possession of a provider at the availability and convenience of the supplier rather than by express designation of the medical services provider.

In this regard, under an embodiment of the present invention, a provider 106 can utilize an Internet web page to pick a specific date of delivery of vaccine from a supplier 108. Supplier 108, due to the sophistication of its computer-implemented processes, enjoys the benefits of both: (i) the ability to offer specific delivery date options to the provider 106, and (ii) the ability to deliver the vaccine on the chosen delivery date with a high degree of reliability. The sophistication demonstrated by such an embodiment of the aforementioned computer-implemented processes can be described in further detail as follows.

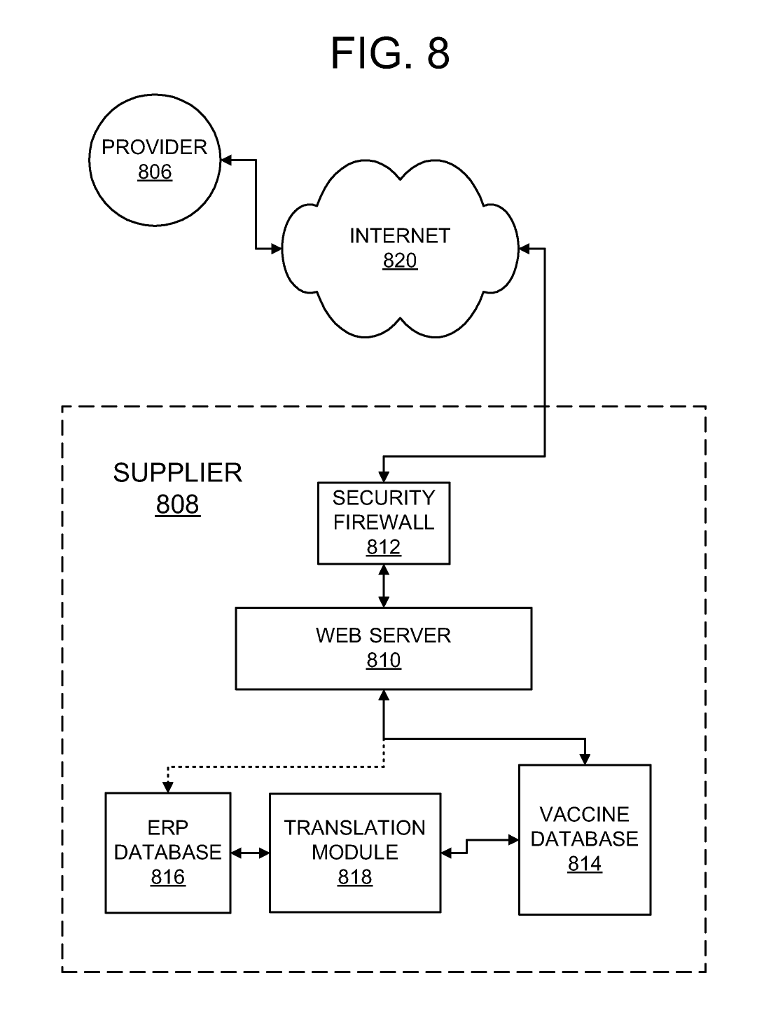

Turning to FIG. 8, an exemplary computer-implemented embodiment of the present invention is illustrated via the relationships between various components of a supplier's vaccine distribution system. The most basic components of infrastructure of a supplier 808 can be described as having a web server 810, a vaccine database 814 and an ERP database 816. Optionally and preferably, the system consists also of a security firewall 812 and a translation module 818.

With respect to the steps of such a method of distributing vaccine, a provider 806 logs onto the web page of a supplier 808 via an Internet 820 connection. Web pages are provided by a web server 810 that preferably has a security firewall 812 installed to prevent unauthorized activity across the Internet 820 connection.

The web server 810 is a device which serves as a front interface or vehicle to provide and solicit information to/from a provider 106 regarding the particulars of a vaccine transaction, (e.g. selecting a delivery date, payment of the order, inquires as to status of the order, etc.). Web server 810 acquires and delivers information to and from the vaccine database 814, which typically comprises a database containing data related to such vaccine transactions, (e.g. vaccine orders, delivery dates, number of doses, etc.). Web server 810 can take the form of any number of common web servers known in the art, such as an Apache web server or a Microsoft Windows .NET server platform. The security firewall 812 can likewise be any number of security devices or parameters typically installed on web servers known in the art, such as a Cisco PIX security appliance.

As desired, supplier 808 can configure web server 810 to also present information on web pages from an ERP database 816, typically containing business-related data of the supplier 808, (e.g. accounting data, human resources data, etc.) that is associated with a given vaccine transaction. In FIG. 8, this optional flow of information is designated by the dotted line running from ERP database 816 to web server 810.

Preferably, information and data between the ERP database 816 and vaccine database 814 should be shared and reconciled between the databases. If the databases are in separate proprietary formats, (e.g. such as a Microsoft SQL database server and a non-SQL database server), then it is preferable to have a translation module 818 to translate, share and reconcile the data between the respective databases.

Utilizing the aforementioned described system illustrated in FIG. 8, a supplier 808 can readily offer additional options for a vaccine transaction such as the flexibility of delivery dates supported by a guarantee of the chosen delivery date—options that are not otherwise offered in the vaccine distribution industry. At the same time, supplier 808 is capable of delivering the vaccine on time with an increased degree of reliability.

### CONCLUSION

The novel approach described herein for determining eligibility, scheduling, distributing and administrating vaccines provides several advantages over prior approaches. First, the computerized analysis and determination of whether a given prospective patient qualifies to receive a vaccination is more reliable than the same analysis performed by a human being. Second, prospective patients can efficiently and reliably setup an appointment to receive a vaccination at their choice of a local medical provider at a convenient time. Lastly, the inventory of vaccines on a local and national level can be more efficiently distributed and administered in compliance with governmental regulations due to the real-time scheduling of appointments.

In sum, the present invention provides significant advantages of efficiency, reliability and convenience in administration of vaccines enjoyed by patients, providers, suppliers and governmental organizations.

In the foregoing specification, the invention has been described as applicable to an implementation anticipating Internet based flu vaccine eligibility, scheduling, distribution and administrative services, where the special advantages of the method are very desirable. However the same invention may be applied with other vaccines, medicines or products requiring a special medical or administrative service to be delivered in conjunction with the vaccine or product.

### PRESENT DISCLOSURE

Unless otherwise indicated, all numbers expressing quantities of ingredients, properties such as molecular weight, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on those embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications, if any, are individually incorporated by reference herein in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A method of distributing a vaccine, comprising the steps of:
providing a supplier, the supplier having an inventory of the vaccine;
providing a provider, the provider capable of administering the vaccine and having a pool of available appointments;
providing a patient, the patient having a need for the vaccine;
exchanging information between the administrator and the supplier, the provider and the patient via a wide area network;
scheduling an appointment for the patient with a provider via the wide area network;
requesting the inventory of the vaccine be transferred from the supplier to the provider via the wide area network; and,
administering the vaccine to the patient by the provider.

2. The method of distributing a vaccine according to claim 1, further comprising the step of determining whether the patient is eligible to receive the vaccine via the wide area network.

3. The method of claim 2 wherein the step of determining whether the patient is eligible to receive the vaccine is based upon whether the patient is entitled to vaccination under government regulations.

4. The method of distributing a vaccine according to claim 1, further comprising the step of removing a scheduled appointment from the pool of available appointments following the step of scheduling an appointment for the patient via the wide area network.

5. The method of distributing a vaccine according to claim 1, further comprising the step of providing a consumer alert to the patient via the wide area network.

6. The method of distributing a vaccine according to claim 1, further comprising the step of processing the billing arrangements for the patient via the wide area network.

7. The method of distributing a vaccine according to claim 1, further comprising the step of administrating post-treatment activities via the wide area network following the step of administering the vaccine to the patient.

8. A computer-readable medium for distributing a vaccine, the computer-readable medium carrying one or more sequences of one or more instructions which, when executed by one or more processors, cause the one or more processors to perform the computer-implemented steps of the method of claim 1.

9. An apparatus for distributing a vaccine, comprising:
one or more processors; and
a memory communicatively coupled to the one or more processors, the memory including one or more sequences of one or more instructions which, when executed by the one or more processors, cause the one or more processors to perform the steps of the method of claim 1.

10. The method of distributing a vaccine according to claim 1, further comprising the steps of:
determining whether the patient is eligible to receive the vaccine via the wide area network prior to scheduling an appointment for the patient;
removing a scheduled appointment from the pool of available appointments via the wide area network following the step of scheduling an appointment for the patient;
providing a consumer alert to the patient via the wide area network;
processing the billing arrangements for the patient via the wide area network;
determining whether the inventory of the vaccine has been transferred from the supplier to the provider prior to the step of administering the vaccine to the patient; and,
administrating post-treatment activities via the wide area network following the step of administering the vaccine to the patient.

11. A computer-readable medium for distributing a vaccine, the computer-readable medium carrying one or more sequences of one or more instructions which, when executed by one or more processors, cause the one or more processors to perform the computer-implemented steps of the method of claim 10.

12. An apparatus for distributing a vaccine, comprising:
one or more processors; and
a memory communicatively coupled to the one or more processors, the memory including one or more sequences of one or more instructions which, when executed by the one or more processors, cause the one or more processors to perform the steps of the method of claim 10.

13. A method of providing vaccine to a patient, comprising the steps of:
exchanging information with an administrator via a wide area network;
scheduling an appointment with a provider via a wide area network; and
attending the appointment, whereby the vaccine is provided to the patient by the provider.

14. A computer-readable medium for providing vaccine to a patient, the computer-readable medium carrying one or more sequences of one or more instructions which, when executed by one or more processors, cause the one or more processors to perform the computer-implemented steps of the method of claim 13.

15. An apparatus for providing vaccine to a patient, comprising:
one or more processors; and
a memory communicatively coupled to the one or more processors, the memory including one or more sequences of one or more instructions which, when executed by the one or more processors, cause the one or more processors to perform the steps of the method of claim 13.

16. A method of providing vaccination services by a provider, comprising the steps of:
exchanging information with an administrator via a wide area network;
receiving a reservation for an appointment with a patient via a wide area network; and
attending the appointment, whereby the vaccine is provided to the patient by the provider.

17. A computer-readable medium for providing vaccination services by a provider, the computer-readable medium carrying one or more sequences of one or more instructions which, when executed by one or more processors, cause the one or more processors to perform the computer-implemented steps of the method of claim 16.

18. An apparatus for providing vaccination services by a provider, comprising:
one or more processors; and
a memory communicatively coupled to the one or more processors, the memory including one or more sequences of one or more instructions which, when executed by the one or more processors, cause the one or more processors to perform the steps of the method of claim 16.

19. A method of supplying vaccine to a provider, comprising the steps of:
exchanging information with an administrator via a wide area network;
receiving a request to supply vaccine to a provider via a wide area network; and
transferring possession of the vaccine to the provider.

20. A computer-readable medium for supplying vaccine to a provider, the computer-readable medium carrying one or more sequences of one or more instructions which, when executed by one or more processors, cause the one or more processors to perform the computer-implemented steps of the method of claim 19.

21. An apparatus for supplying vaccine to a provider, comprising:
one or more processors; and
a memory communicatively coupled to the one or more processors, the memory including one or more sequences of one or more instructions which, when executed by the one or more processors, cause the one or more processors to perform the steps of the method of claim 19.
